(19) United States
(12) Patent Application Publication
(10) Pub. No.: US 2010/0145914 A1
(43) Pub. Date: Jun. 10, 2010

(54) DATABASE MANAGEMENT SERVER APPARATUS, DATABASE MANAGEMENT SYSTEM, DATABASE MANAGEMENT METHOD AND DATABASE MANAGEMENT PROGRAM

(75) Inventors: Yuji Kanno, Kanagawa (JP); Mitsuaki Inaba, Tokyo (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/472,680

(22) Filed: May 27, 2009

(30) Foreign Application Priority Data
Jun. 9, 2008 (JP) 2008-150211

(51) Int. Cl. G06F 17/00; G06F 12/00

(52) U.S. Cl. 707/638; 707/674; 707/E17.005

(57) ABSTRACT

Provided is a database management server apparatus that can maintain the consistency of updates and prevent blocking other update requests in an update process.

A server apparatus 3 of a database management system 1 has a function of nondestructively updating databases in response to an update request from a client apparatus 2 to manage generation-management databases. A main storage unit 4 stores entities of a plurality of databases for each version of the databases, and a version creating unit 5 creates a new version of the databases in response to an update request from a client apparatus. A request accepting unit 11 accepts an update request for a next version regardless of whether the new version is being created. An acceptance management unit 13 starts a period for accepting the update request for the next version in response to the update request and ends the period for accepting after a predetermined time. A version creating unit 5 creates the next version based on the update request accepted in the period for accepting.

### BACKGROUND OF THE INVENTION

1. Field of the Invention

The present invention relates to a database management server apparatus having a function of managing generation-management databases.

2. Description of the Related Art

In recent years, information technology is widely used as a result of the improved performance and decreased cost of computers and networks as well as the development and proliferation of the Internet communication environment. In the information technology, a database management system for managing relational databases and document databases is widely used as middleware that can easily maintain and manage various data independent from various application systems, maintain the consistency of data, recover from a trouble or failure, and execute an advanced search process and as the core of various information systems.

One of the database management systems introduces a concept of “generation” of databases to manage the generation of the databases (for example, Japanese Patent Laid-Open No. 2002-366547 and Narayanan. Shivakumar and Hector G. Molina: “Wave-Indices: Indexing Evolving Databases”, AMCSIGMOD '97, pp. 381, ACM, 1997).

Such generation-management database management system nondestructively executes an update process of databases. Thus, the next database is created without changing the entities of the current database. Therefore, the generation-management database management system has excellent characteristics, such as the following (1) to (3), as compared to a database management system that executes a destructive update.

(1) The fault tolerance is excellent because the possibility that the content of the current database (before the update) will not be destructed is high even if there are various troubles or failures in the middle of the update process, such as mechanical and electrical accidents including earthquake and blackout, or the storage device is full.

(2) The consistency of search results in a plurality of related search requests can be easily realized because there is no influence from the update process as long as the search processes are executed in a designated generation even during the update of the databases.

(3) There is less reduction in the search performance during the update process.

A conventional generation-management database management system maintains the consistency of updates to prevent a problem that the successfully updated data cannot be searched after the completion of the update. However, blocking of execution occurs in the search process or the update process if an attempt is made to maintain the consistency of the updates. For example, the state becomes “next generation is being created” during processing of a database update request from a client apparatus, and an update request from another client apparatus is suspended. Therefore, it has been desired to reduce the time from the transmission of an update request by the client apparatus to the reception of a notification of the update completion.

Moreover, in the conventional database management system nondestructively updates the databases, the overhead of the update process is large compared to a destructive update process (or an update process without the generation management), and the update time is relatively long for the client apparatus, even if the blocking described above does not occur. Thus, a reduction in the update time for the client apparatus has been desired.

### SUMMARY OF THE INVENTION

The present invention has been made to solve the conventional problem, and an object of the present invention is to provide a database server apparatus that can maintain the consistency of updates and that can prevent the occurrence of blocking time in an update process.

The present invention provides a database management server apparatus having a function of nondestructively updating databases in response to an update request from a client apparatus to manage generation-management databases, the database management server apparatus comprising: version storage means for storing entities of a plurality of databases for each version of the databases; version creating means for creating a new version of the databases in response to an update request from the client apparatus; update request accepting means for accepting an update request for a next version of the databases from the client apparatus regardless of whether the new version is being created; and acceptance management means for starting an period for accepting update requests to make the next version in response to the (update) request from the client apparatus and ending the period for accepting update requests to make the next version after a predetermined time, wherein the version creating means creates the next version of the databases in response to the update request for the next version accepted in the period.

According to the configuration, if there is an update request from a client apparatus, an update request for a next version (for example, version X+1) is accepted during the creation of a new version (for example, version X) of databases, and a period for accepting the update request for the next version is started. The period for accepting the update request ends after a predetermined time, and all update requests accepted in the period for accepting are organized to create the next version. In this way, the occurrence of blocking execution in the update process (waiting time until the acceptance of the update request) can be prevented. The consistency of updates is also maintained by the management of generation-management databases. In this paragraph, the update request for the next version of the databases is defined as a request of an update reflected in the next version of the databases.

The database management server apparatus of the present invention further comprises: update collision determining means for determining whether there is a collision between the update request from the client apparatus in the period for accepting and an update request accepted in the past; and scheduled version name notification means for notifying a scheduled version name of the databases to the client apparatus when the update collision determining means determines that there is no update collision, the scheduled version name being provided as an acceptance completion notification of the update request from the client apparatus.

According to the configuration, the existence of a collision between an update request from a client apparatus in the period for accepting and an update request accepted in the past can be determined. If there is no update collision, a scheduled version name is notified as an acceptance completion notification of the update request. The use of the scheduled version name as an acceptance completion notification of the update request allows the client apparatus that has sent the update request to check whether the update request is accepted and to recognize the version that the update request will be reflected.

In the database management server apparatus of the present invention, the scheduled version name notification means notifies the scheduled version name of the database to the client apparatus in reply to the update request from the client apparatus.

According to the configuration, a scheduled version name is notified in reply to the update request from the client apparatus. As a result, the client apparatus that has sent the update request can quickly check whether the update request is accepted and immediately recognize the version that the update request will be reflected. Therefore, for example, when a trouble or failure occurs in the database management server apparatus after the transmission of the update request, whether the update request is accepted, or whether the update request is reflected, can be easily checked after the recovery process from the trouble or failure.

The database management server apparatus of the present invention further comprises: update log storage means for storing an update state of each version of the databases, the update state being provided as an update log of the databases; update state notification means for notifying the update state of the version of the databases in response to a confirmation request from a client apparatus; creation log recording means for recording the completion of the creation of the new version in the update log when the creation of the new version of the databases is completed; and discarding means for discarding, in a recovery process from a trouble of the database management server apparatus, the version being created in which the completion of the creation is not recorded in the update log when the trouble occurs.

According to the configuration, when the creation of a new version of the databases is completed, the completion of the creation of the version is recorded in the update log. When a trouble occurs in the database management server apparatus, the version being created in which the completion of the creation is not recorded in the update log is discarded in the recovery process from the trouble. The update state (such as “creation completed” and “discarded”) of the version of the databases is notified in response to the confirmation request from the client apparatus. Therefore, the client apparatus can easily check whether the scheduled version reflecting the transmitted update request is created, or whether the transmitted update request needs to be retransmitted, when a trouble occurs in the database management server apparatus. Once the creation of the new version is completed, the version can be searched by any clients. Therefore, the creation completed state of the version can also be called a searchable state of the version. Other than the creation completed state (searchable state), update states of the version include, for example, an accepting state and a creating state.

The database management server apparatus of the present invention further comprises: version deleting means for deleting a version of the databases; and deleted log recording means for saving the deleted version name of the databases as an update log of the database when the version is deleted.

According to the configuration, the version name (including the scheduled version name) remains in the update log even if the version of the databases is deleted. Therefore, whether the version of the databases with a certain version name existed in the past, or for example, whether the update request that one has transmitted in the past is reflected, can be easily checked even after the deletion of the version of the databases. This works with very low overhead because a significantly less amount of data is required for the version name of the databases compared to the entities of the databases.

In the database management server apparatus of the present invention, the acceptance management means sets the end of the period for accepting the update request to after the completion of the creation of the new version when the update request for the next version is accepted from the client apparatus during the creation of the new version.

According to the configuration, the end of the period for accepting the update request is set after the completion of the creation of the new version. In this case, the creation of the next version (version in which the accepted update request will be reflected) cannot be started until the completion of the creation of the new version (version being created). Therefore, the acceptance of the update request for the next version is designed to end after the completion of the creation of the new version. As a result, the efficiency of the update acceptance can be improved.

In the database management server apparatus of the present invention, the acceptance management means determines the end of the period for accepting the update request according to the number of acceptances of the update requests when the update requests of the next version are accepted from the client apparatus during the creation of the new version.

According to the configuration, the end of the period for accepting the update request is determined based on the number of acceptances of the update requests. For example, the period for accepting the update request is designed to end when a certain number of update requests are accepted. As a result, the period for accepting the update request can be controlled to a suitable length.

A database management system of the present invention comprises: a client apparatus having a function of sending an update request for databases; and a database management server apparatus having a function of nondestructively updating the databases in response to the update request from the client apparatus to manage generation-management databases, the database management server apparatus comprising: version storage means for storing entities of a plurality of databases for each version of the databases; version creating means for creating a new version of the databases in response to an update request from the client apparatus; update request accepting means for accepting an update request for a next version of the databases from the client apparatus regardless of whether the new version is being created; and acceptance management means for starting an period for accepting the update request for the next version in response to the update request from the client apparatus and ending the period for accepting the update request for the next version after a predetermined time, wherein the version creating means creates the next version of the databases in response to the update request for the next version accepted in the period for accepting.

According to the system, when an update request is sent from a client apparatus, an update request for a next version (for example, version X+1) is accepted during the creation of a new version (for example, version X) of databases, and an period for accepting the update request for the next version is started. The period for accepting the update request ends after a predetermined time, and the update requests accepted in the period for accepting are organized to create the next version. In this way, the occurrence of blocking execution in the update process (waiting time until the acceptance of the update request) can be prevented. The consistency of updates is also maintained by the management of generation-management databases.

The present invention provides a database management method used in a database management server apparatus having a function of nondestructively updating databases in response to an update request from a client apparatus to manage generation-management databases, the database management server apparatus storing entities of a plurality of databases for each version of the databases and having a function of creating a new version of the databases in response to an update request from the client apparatus; the database management method comprising: accepting an update request for a next version of the databases from the client apparatus regardless of whether the new version is being created; starting an period for accepting the update request for the next version in response to the update request from the client apparatus and ending the period for accepting the update request for the next version after a predetermined time; and creating the next version of the databases in response to the update request for the next version accepted in the period for accepting.

According to the method, if there is an update request from a client apparatus, an update request for a next version (for example, version X+1) is accepted during the creation of a new version (for example, version X) of databases, and an period for accepting the update request for the next version is started. The period for accepting the update request ends after a predetermined time, and all update requests accepted in the period for accepting are organized to create the next version. In this way, the occurrence of blocking execution in the update process (waiting time until the acceptance of the update request) can be prevented. The consistency of updates is also maintained by the management of generation-management databases.

The present invention provides a database management program executed in a database management server apparatus having a function of nondestructively updating databases in response to an update request from a client apparatus to manage generation-management databases, the database management server apparatus storing entities of a plurality of databases for each version of the databases and having a function of creating a new version of the databases in response to an update request from the client apparatus; the database management program causing a computer to execute: a process of accepting an update request for a next version of the databases from the client apparatus regardless of whether the new version is being created; a process of starting an period for accepting the update request for the next version in response to the update request from the client apparatus and ending the period for accepting the update request for the next version after a predetermined time; and a process of creating the next version of the databases in response to the update request for the next version accepted in the period for accepting.

According to the program, if there is an update request from a client apparatus, an update request for a next version (for example, version X+1) is accepted during the creation of a new version (for example, version X) of databases, and a period for accepting the update request for the next version is started. The period for accepting the update request ends after a predetermined time, and the update requests accepted in the period for accepting are organized to create the next version. In this way, the generation of a waiting time in the update process (waiting time until the acceptance of the update request) can be prevented. The consistency of updates is also maintained by the management of generation-management databases.

The present invention provides update requesting means for accepting an update request from a client apparatus regardless of whether a new version is being created and version creating means for creating a next version in response to an update request accepted in an period for accepting started in response to the update request. Therefore, the present invention can provide a database management server apparatus that can maintain the consistency of updates and prevent the occurrence of blocking execution in the update process.

### BRIEF DESCRIPTION OF THE DRAWINGS

FIG. 1 is a block diagram of a configuration of a database management system according to an embodiment of the present invention;

FIG. 2 is a block diagram of a configuration of a version update control unit;

FIG. 3 is an explanatory view of an operation of a database management system (asynchronous type of request) according to an embodiment of the present invention;

FIG. 4 is an explanatory view of an operation of a database management system (synchronous type of request) according to the embodiment of the present invention;

FIG. 5 is an explanatory view of an operation of the database management system (asynchronous type of request) in a recovery process from a trouble;

FIG. 6 is an explanatory view of an operation of the database management system (synchronous type of request) in the recovery process from the trouble;

FIG. 7 is a flow chart for explaining an operation of an acceptance process of an update request;

FIG. 8 is a flow chart for explaining an operation of an acceptance process of a confirmation request; and

FIG. 9 is a flow chart for explaining an operation of a recovery (restart) process from a trouble.

### DETAILED DESCRIPTION OF THE PREFERRED EMBODIMENT

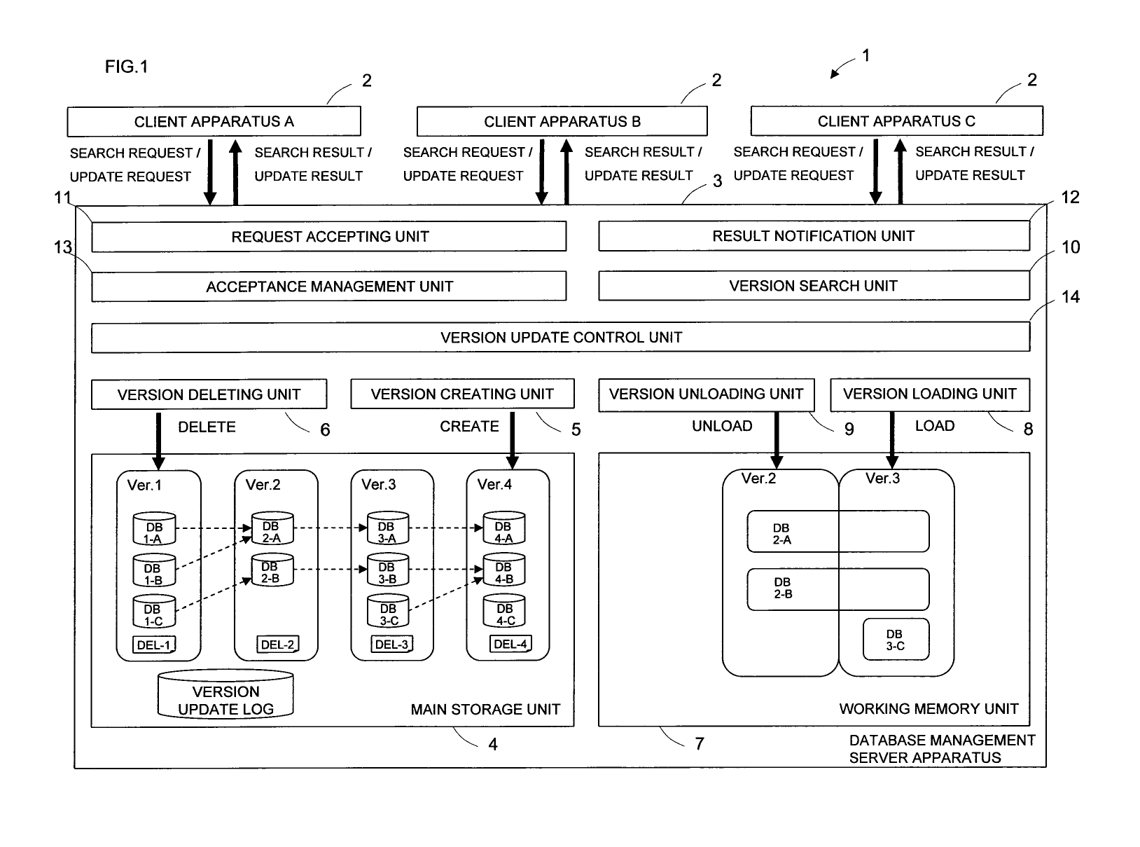

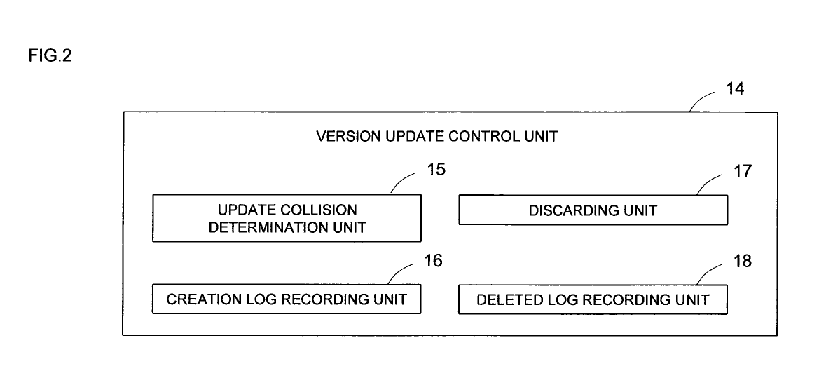

A database management system of an embodiment of the present invention will now be described with reference to the drawings. A configuration of the database management system of the present embodiment will be described first with reference to FIGS. 1 and 2.

FIG. 1 is a block diagram of a configuration of the database management system of the present embodiment. As shown in FIG. 1, a database management system 1 is constituted by client apparatuses 2 that send search requests and update requests and a database management server apparatus 3 (also simply called a server apparatus 3) that returns search results and update results in response to the search requests and the update requests. Only three client apparatuses 2 (client apparatuses A to C) and one server apparatus 3 are illustrated in the example of FIG. 1 for convenience of description. However, the numbers of the client apparatuses 2 and the server apparatus 3 are not limited to these.

As described below, the server apparatus 3 of the present embodiment has a function of nondestructively updating databases in response to an update request from the client apparatuses 2 to manage generation-management databases. The function is executed by a program stored in a memory or the like (not shown) of the server apparatus 3.

As shown in FIG. 1, the server apparatus 3 includes a main storage unit 4 that stores entities (such as a directory and a file) of a plurality of databases for each version of the databases. The main storage unit 4 stores four versions (versions 1 to 4) in the example of FIG. 1. The main storage unit 4 also stores a version update log of the databases. The version update log indicates an update state (such as an accepting state, a creating state, and a searchable state (creation completed state)) of the versions of the databases. The main storage unit 4 is equivalent to version storage means and update log storage means of the present invention.

The server apparatus 3 includes a version creating unit 5 that stores a new version of the databases in the main storage unit 4 and a version deleting unit 6 that deletes an existing version stored in the main storage unit 4. The version creating unit 5 has a function of creating a new version of the databases in response to an update request from the client apparatus 2. As described below, the version creating unit 5 has a function of creating a next version of the databases in response to an update request for the next version accepted in a predetermined period for accepting. The version creating unit 5 is equivalent to version creating means of the present invention.

The server apparatus 3 includes a working memory unit 7 that temporarily stores entities of versions (created versions) of the databases stored in the main storage unit 4 for operations such as searching and referencing. The temporary storage in the working memory unit 7 will be referred to as “loading”, and the deletion from the working memory unit 7 will be referred to as “unloading”.

The server apparatus 3 includes a version loading unit 8 that loads the entities of the versions (created versions) of the databases stored in the main storage unit 4 onto the working memory unit 7 and a version unloading unit 9 that unloads the entities of the versions from the working memory unit 7. Two versions (versions 2 and 3) are loaded onto the working memory unit 7, and an old version (version 1) that does not have to be referenced is unloaded from the working memory unit 7 in the example of FIG. 1. The server apparatus 3 further includes a version search unit 10 that searches versions of the databases loaded onto the working memory unit 7.

As shown in FIG. 1, the server apparatus 3 includes a request accepting unit 11 that accepts search requests and update requests from the client apparatuses 2 and a result notification unit 12 that notifies search results and update results to the client apparatus 2 in response to the search requests and the update requests. The request accepting unit 11 can accept an update request for a next version from the client apparatuses 2 regardless of whether the version creating unit 5 is creating a new version. The request accepting unit 11 is equivalent to update request accepting means of the present invention.

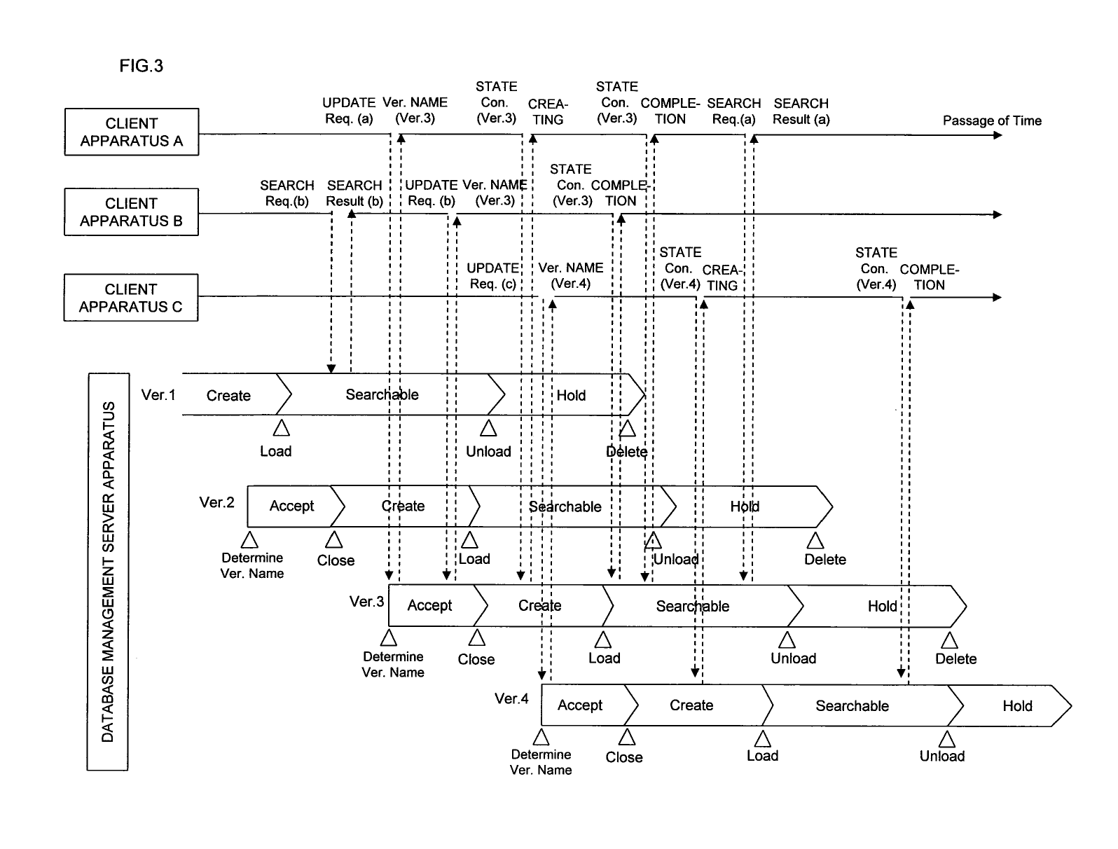

The server apparatus 3 further includes an acceptance management unit 13 that starts an period for accepting the update request when an update request from the client apparatuses 2 is accepted and that ends the period for accepting after a predetermined certain time. The acceptance management unit 13 starts a period for accepting the update request for a next version (for example, version 3) when an update request from the client apparatuses 2 is accepted during the creation of a new version (for example, version 2). The acceptance management unit 13 sets the end of the period for accepting the update request for the next version (version 3) to after the completion of the creation of the new version (version 2) (see, for example, FIG. 3). The period for accepting may end after the reception of a certain number of update requests if a multiplicity of update requests are sent after the start of the acceptance of the update requests. In either case, the acceptance management unit 13 is equivalent to acceptance management means of the present invention.

The server apparatus 3 includes a version update control unit 14 that controls the version creating unit 5, the version deleting unit 6, the version loading unit 8, the version unloading unit 9, and the like to control the updates of the versions of the databases. Functions of the version update control unit 14 will now be described in detail with reference to FIG. 2.

FIG. 2 is a block diagram for explaining functions of the version update control unit 14. As shown in FIG. 2, the version update control unit 14 includes an update collision determination unit 15 that determines whether there is a collision between an update request from the client apparatuses 2 in the period for accepting and an update request accepted in the past.

The update collision determination unit 15 examines the consistency of the update data included in the update request from the client apparatuses 2 and the update data included in the update requests accepted in the past (such as update data included in the update requests accepted earlier in the period for accepting, update data of the version being created, and update data of created versions). Specifically, the update collision determination unit 15 determines whether the ID of the update data included in the update request from the client apparatuses 2 matches any of the IDs of the update data included in the update requests accepted in the past.

If the update collision determination unit 15 determines that there is no collision of the update requests (IDs of the update data do not match), the result notification unit 12 notifies a scheduled version name of the database to the client apparatuses 2 as an acceptance completion notification of the update request from the client apparatuses 2. The update collision determination unit 15 is equivalent to update collision determining means of the present invention, and the result notification unit 12 is equivalent to scheduled version name notification means of the present invention.

The scheduled version name of the database is a version name of the database that will be created next. For example, the version name (scheduled version name) of the next version of the databases is “version 3” when a new version of the database with a version name “version 2” is being created. An accepted time of the update request from the client apparatus 2 may be used as the version name. For example, the version name (scheduled version name) of the next version is “version YYYYMMDD123456” if the update request from the client apparatus 2 is accepted at 12:34:56 of MM month DD day, YYYY year.

As shown in FIG. 2, the version update control unit 14 includes a creation log recording unit 16 and a discarding unit 17. The creation log recording unit 16 has a function of recording “creation completed” of a new version in the version update log as an update state of the new version when the creation of the new version of the database is completed. The discarding unit 17 has a function of discarding, in a recovery process from a trouble (when restarting), a version (version being created) in which “creation completed” is not recorded in the version update log when the trouble occurs in the server apparatus 3.

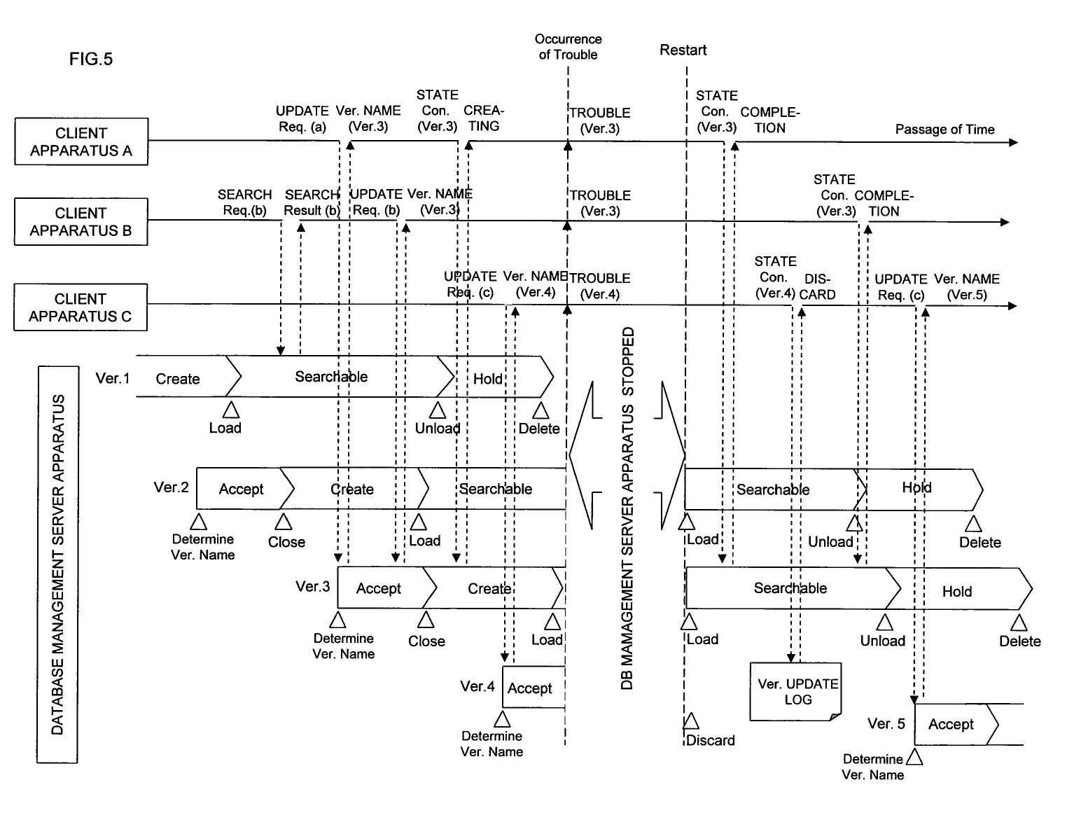

For example, if the creation of the “version 3” is completed but the creation of the “version 4” is not completed when a trouble occurs in the server apparatus 3, the “version 3” is not discarded in the recovery process from the trouble because “creation completed” of the “version 3” is recorded in the version update log. Therefore, the result notification unit 12 of the server apparatus 3 notifies “creation completed” as an update state of the “version 3” to the client apparatus 2 when there is a confirmation request of the “version 3” from the client apparatus 2 later (see, for example, FIG. 5).

On the other hand, the “version 4” is discarded in the recovery process from the trouble because “creation completed” of the “version 4” is not recorded in the version update log. Therefore, the result notification unit 12 of the server apparatus 3 notifies “discarded” as an update state of the “version 4” to the client apparatus 2 when there is a confirmation request of the “version 4” from the client apparatus 2 later (see, for example, FIG. 5). The creation log recording unit 16 is equivalent to creation log recording means of the present invention, and the discarding unit 17 is equivalent to discarding means of the present invention. The result notification unit 12 is equivalent to update state notification means of the present invention.

As shown in FIG. 2, the version update control unit 14 further includes a deleted log recording unit 18. The deleted log recording unit 18 has a function of recording the scheduled version name of the deleted database as a version update log of the database when the version deleting unit 6 deletes the version of the database. For example, the deleted log recording unit 18 records the version name “version 1” in the version update log when the “version 1” is deleted from the main storage unit 4 (see FIG. 1). The deleted log recording unit 18 is equivalent to deleted log recording means of the present invention.

Operations of the database management system 1 configured this way will be described with reference to FIGS. 3 to 9.

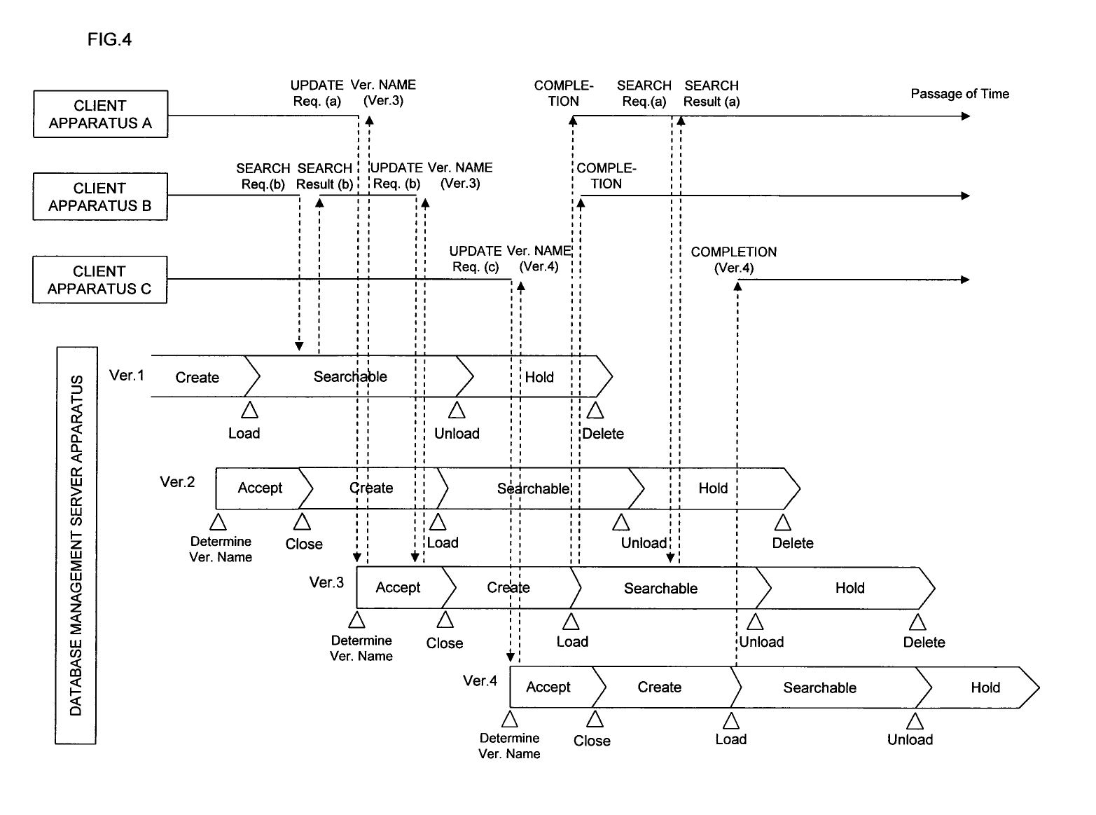

Normal operations (operations when there is no trouble) of the database management system 1 will be described first with reference to FIGS. 3 and 4. FIG. 3 is an explanatory view of an operation of an asynchronous database management system 1. The “asynchronous” system is a system for notifying a scheduled version name (version name in which an update request will be reflected) to the client apparatus 2 even if an update request from the client apparatus 2 is not reflected.

FIG. 3 illustrates an example in which four versions (versions 1 to 4) of databases are managed in parallel (like a pipeline) in the server apparatus 3, and update requests and confirmation requests from three client apparatuses 2 (client apparatuses A to C) are processed.

The creation of the “version 1” of the databases is completed in the server apparatus 3, and the “version 1” is loaded. Therefore, the “version 1” is “searchable”. The server apparatus 3 uses the “version 1” to execute a search process when the client apparatus B sends a search request b to the server apparatus 3, and a search result b is notified to the client apparatus B.

The client apparatus A then sends an update request a to the server apparatus 3. At this point, the period for accepting the update request for the “version 2” of the databases has ended in the server apparatus 3, and the “version 2” is being created. In such a case, the server apparatus 3 starts an period for accepting the update request for the “version 3”, which is the next version, in response to the update request a from the client apparatus A. A version name “version 3” is notified to the client apparatus A in response to the update request a.

Subsequently, the client apparatus B sends an update request b to the server apparatus 3. In this case, the period for accepting the update request for the “version 3” has not ended because the creation of the “version 2” is not completed in the server apparatus 3. Therefore, the server apparatus 3 determines whether there is a collision between the update request b from the client apparatus B and the update request a accepted in the period for accepting. If there is no collision, a version name “version 3” is notified to the client apparatus B in consequence.

Once the creation of the “version 2” is completed, the server apparatus 3 closes the period for accepting the “version 3” and starts creating the “version 3”. When the client apparatus A sends a confirmation request of the update state of the “version 3” to the server apparatus 3, the server apparatus 3 notifies the update state “creating” to the client apparatus A in response to the confirmation request.

The client apparatus C then sends an update request c to the server apparatus 3. As in the case described above, the period for accepting the update request for the “version 3” of the databases has ended in the server apparatus 3, and the “version 3” is being created. Therefore, the server apparatus 3 starts an period for accepting the update request for the “version 4”, which is the next version, in response to the update request c from the client apparatus C. A version name “version 4” is notified to the client apparatus C in response to the update request c.

When the client apparatuses A and B send confirmation requests of the update state of the “version 3” to the server apparatus 3 after the creation of the “version 3” is completed and the “version 3” is loaded, the server apparatus 3 notifies the update state “creation completed” to the client apparatuses A and B in response to the confirmation requests.

Once the client apparatus A sends the search request a to the server apparatus 3, the server apparatus 3 uses the “version 3 (version that the update request a from the client apparatus A is reflected)” to execute a search process and notifies a search result a to the client apparatus A.

Once the creation of the “version 3” is completed, the server apparatus 3 closes the period for accepting the “version 4” and starts creating the “version 4”, as in the case described above. When the client apparatus C sends a confirmation request of the update state of the “version 4” to the server apparatus 3, the server apparatus 3 notifies the update state “creating” to the client apparatus C in response to the confirmation request. When the client apparatus C sends a confirmation request of the update state of the “version 4” to the server apparatus 3 after the creation of the “version 4” is completed and the “version 4” is loaded, the server apparatus 3 notifies the update state “creation completed” to the client apparatus C in response to the confirmation request.

The update state of the version of the databases will be described with reference to FIG. 3. A version name (scheduled version name) of the version of the databases is determined when there is an update request from the client apparatuses 2. The period for accepting is then started, and the state becomes “accepting”. When the period for accepting ends, the creation of the version is started, and the state becomes “creating”. When the creation of the version is completed and the version is loaded onto the working memory unit 7, the state becomes “searchable”. An old version that does not have to be referenced is unloaded from the working memory unit 7. The unloaded version is not immediately deleted from the main storage unit 4 but is “held” by the main storage unit 4. Although the entities of the version are deleted from the main storage unit 4 after a certain period, the version name is recorded in the version update log.

FIG. 4 is an explanatory view of an operation of a synchronous database management system 1. The “synchronous” system is a system for notifying a version name (version name in which an update request is reflected) to the client apparatuses 2 when an update request from the client apparatuses 2 is reflected.

Differences in the operation of the system of FIG. 4 from the operation of the system of FIG. 3 will be mainly described. Therefore, the operation of the system of FIG. 4 is the same as the operation of the system of FIG. 3 unless otherwise stated.

As shown in FIG. 4, in the synchronous system, the server apparatus 3 sends a version name “version 3” to the client apparatus A in response to an update request a when the client apparatus A sends the update request a to the server apparatus 3. However, the version name does not reach an application control layer of the client apparatus A. In this case, “creation completed” of the “version 3” is notified to the client apparatus A when the creation of the “version 3” is completed and the “version 3” is loaded.

Similarly, the server apparatus 3 sends a version name “version 3” to the client apparatus B in response to an update request b when the client apparatus B sends the update request b to the server apparatus 3. However, the version name does not reach an application control layer of the client apparatus B. In this case, “creation completed” of the “version 3” is notified to the client apparatus B when the creation of the “version 3” is completed and the “version 3” is loaded.

Similarly, the server apparatus 3 sends a version name “version 4” to the client apparatus C in response to an update request c when the client apparatus C sends the update request c to the server apparatus 3. However, the version name does not reach an application control layer of the client apparatus C. In this case, “creation completed” of the “version 4” is notified to the client apparatus C when the creation of the “version 4” is completed and the “version 4” is loaded.

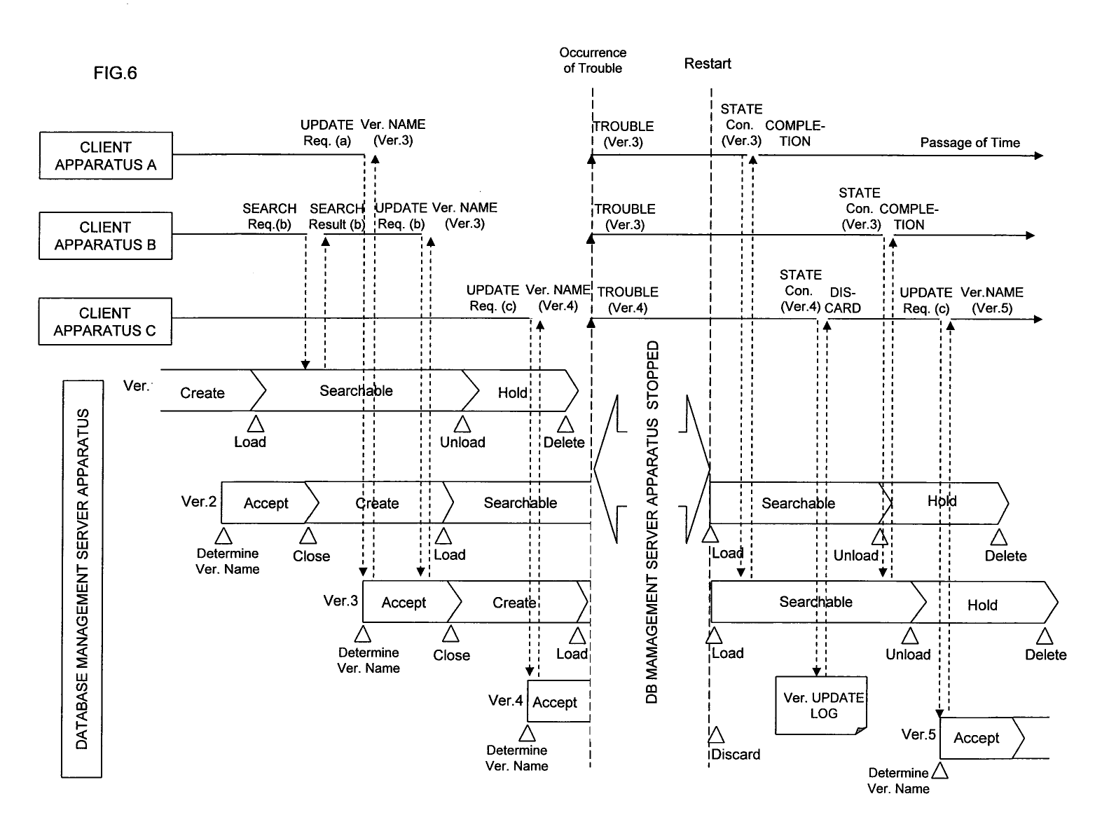

Operations when a trouble occurs in the server apparatus 3 will be described with reference to FIGS. 5 and 6. FIG. 5 is an explanatory view of an operation when there is a server trouble in the asynchronous system. Differences in the operation when a trouble occurs in the server apparatus 3 of the system from the normal operation of FIG. 3 will be mainly described.

In the example of FIG. 5, the client apparatuses A and B send update requests of the “version 3” to the server apparatus 3, and the client apparatus C sends an update request for the “version 4” to the server apparatus 3. When there is a trouble in the server apparatus 3, the state of the “version 3” is “searchable” and the state of the “version 4” is “accepting”. Therefore, “creation completed” of the “version 3” is recorded in the version update log.

As shown in FIG. 5, when a trouble occurs in the server apparatus 3, a trouble notification including the version name of an update request is sent to the client apparatus 2 that has sent the update request. In this case, trouble notifications including the version name “version 3” are sent to the client apparatuses A and B, and a trouble notification including the version name “version 4” is sent to the client apparatus C. The version name does not have to be included in the trouble notification in the asynchronous system because the server apparatus 3 has already sent a version name notification to the client apparatuses 2.

The “version 3” in which “creation completed” is recorded in the version update log is loaded and set to “searchable” when the server apparatus 3 restarts after recovering from the trouble. On the other hand, as for the “version 4” in which “creation completed” is not recorded in the version update log, the version being created is discarded when the server apparatus 3 restarts, and “discarded” is recorded in the version update log.

When the client apparatuses A and B send confirmation requests of the update state of the “version 3” to the server apparatus 3, the server apparatus 3 notifies the update state “creation completed” to the client apparatuses A and B in response to the confirmation requests.

Meanwhile, when the client apparatus C sends a confirmation request of the update state of the “version 4” to the server apparatus 3, the server apparatus 3 notifies the update state “discarded” to the client apparatus C in response to the confirmation request. In this way, the client apparatus C can check that the update request c of the “version 4” is not reflected due to the trouble of the server apparatus 3 and can recognize that the update request c needs to be sent. The client apparatus C resends an update request c to the server apparatus 3 in the example of FIG. 5, and the version name of the second update request c is “version 5”.

FIG. 6 is an explanatory view of an operation when there is a server trouble in the synchronous system. Difference in the operation when a trouble occurs in the server apparatus 3 of the system from the normal operation of FIG. 4 will be mainly described.

In the example of FIG. 6, the client apparatuses A and B send update requests of the “version 3” to the server apparatus 3, and the client apparatus C sends an update request for the “version 4” to the server apparatus 3. As in the example of FIG. 5, the “version 3” is “searchable” and the “version 4” is “accepting” when the trouble occurs in the server apparatus 3. Therefore, “creation completed” of the “version 3” is recorded in the version update log.

As shown in FIG. 6, when a trouble occurs in the server apparatus 3, a trouble notification including the version name of an update request is sent to the client apparatus 2 that has sent the update request. In this case, trouble notifications including the version name “version 3” are sent to the client apparatuses A and B, and a trouble notification including the version name “version 4” is sent to the client apparatus C.

As in FIG. 5, the “version 3” in which “creation completed” is recorded in the version update log is loaded and set to “searchable” when the server apparatus 3 restarts after recovering from the trouble. On the other hand, as for the “version 4” in which “creation completed” is not recorded in the version update log, the version being created is discarded when the server apparatus 3 restarts, and “discarded” is recorded in the version update log.

When the client apparatuses A and B send confirmation requests of the update state of the “version 3” to the server apparatus 3, the server apparatus 3 notifies the update state “creation completed” to the client apparatuses A and B in response to the confirmation requests.

Meanwhile, when the client apparatus C sends a confirmation request of the update state of the “version 4” to the server apparatus 3, the server apparatus 3 notifies the update state “discarded” to the client apparatus C in response to the confirmation request. In this way, the client apparatus C can check that the update request c of the “version 4” is not reflected due to the trouble of the server apparatus 3 and can recognize that the update request c needs to be resent. As in the example of FIG. 5, the client apparatus C resends an update request c to the server apparatus 3 in the example of FIG. 6, and the version name of the second update request c is “version 5”.

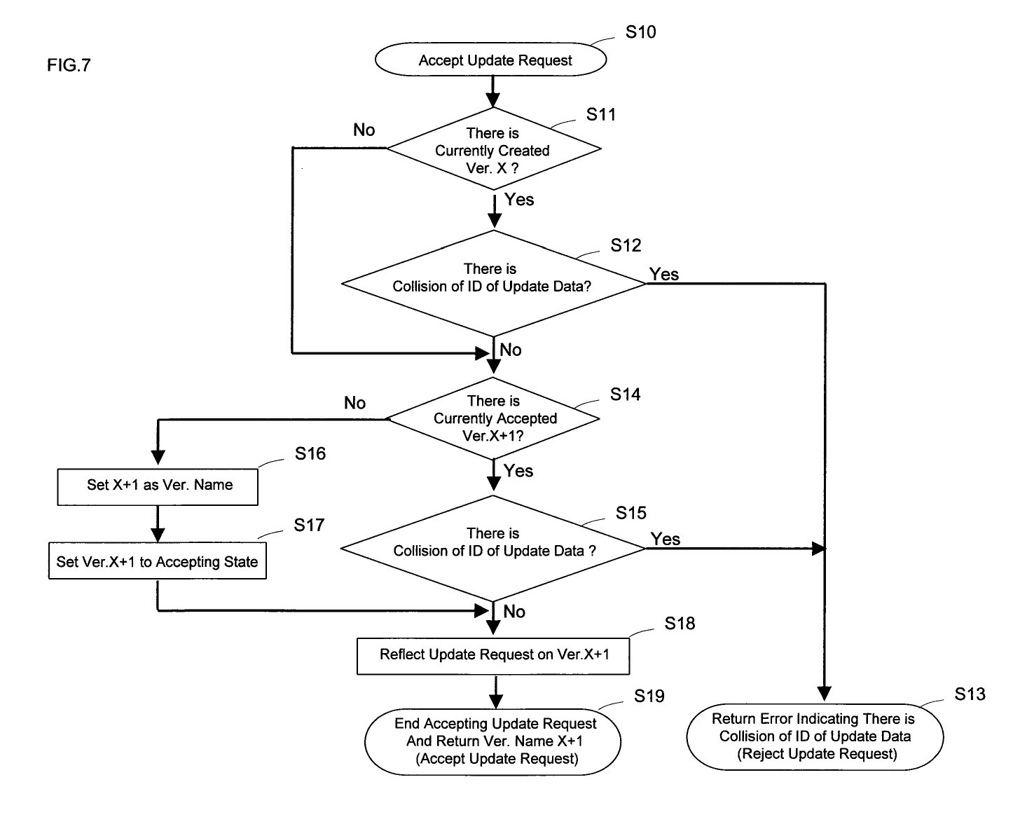

Flows of processes in the server apparatus 3 will be described with reference to FIGS. 7 to 9. FIG. 7 is a flow chart of a flow of an acceptance process of an update request. As shown in FIG. 7, once the server apparatus 3 accepts an update request from the client apparatus 2 (S10), the server apparatus 3 determines whether there is a version currently being created (for example, version X) (S11). If there is a version being created, the server apparatus 3 determines whether there is a collision between the ID of the update data and the IDs of the update data of the version (S12). If there is a collision of the ID of the update data, the server apparatus 3 rejects the update request and returns an error notification to the client apparatus 2 (S13).

If there is no collision of an ID of the update data, the server apparatus 3 determines whether there is a version whose state is “accepting” (for example, version X+1) (S14). If there is a version whose state is “accepting”, the server apparatus 3 determines whether there is a collision between the ID of the update data and the IDs of the update data of the version (S15). If there is a collision of the ID of the update data, the server apparatus 3 rejects the update request and returns an error notification to the client apparatus 2 (S13). If there is no version whose state is “accepting”, the server apparatus 3 determines the scheduled version name “X+1” as a version name (S16) and sets the state of the version (version X+1) to “accepting” (S17).

The server apparatus 3 reflects the update request to the version X+1 (S18), ends accepting the update request, and returns the version name X+1 to the client apparatus 2 (S19). The update request is accepted this way.

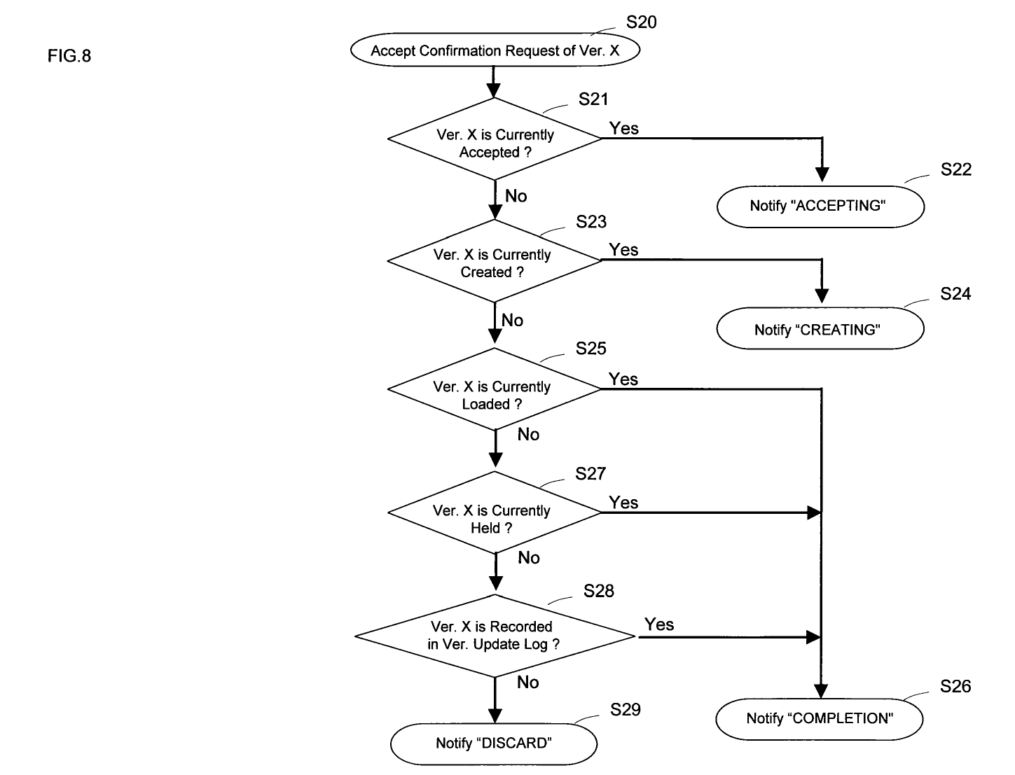

FIG. 8 is a flow chart of a flow of an acceptance process of a confirmation request. As shown in FIG. 8, once the server apparatus 3 accepts a confirmation request of a version (for example, version X) from the client apparatus 2 (S20), the server apparatus 3 refers to the version update log and determines whether the current state of the version X is “accepting” (S21). If the state of the version X is “accepting”, the server apparatus 3 notifies “accepting” to the client apparatus 2 (S22).

If the state of the version X is not “accepting”, the server apparatus 3 refers to the version update log to determine whether the version X is currently created (S23). If the version X is being created, the server apparatus 3 notifies “creating” to the client apparatus 2 (S24).

If the version X is not currently being created, the server apparatus 3 refers to the version update log and determines whether the version X is currently loaded (S25). If the version X is loaded, the server apparatus 3 notifies “creation completed” to the client apparatus 2 (S26).

If the version X is not currently loaded, the server apparatus 3 refers to the version update log and determines whether the version X is currently held (S27). If the version X is held, the server apparatus 3 notifies “creation completed” to the client apparatus 2 (S26).

If the version X is not currently held, the server apparatus 3 determines whether the record of the creation of the version X is in the version update log (S28). If the record is in the version update log, the server apparatus 3 notifies “creation completed” to the client apparatus 2 (S26). On the other hand, if the record is not in the version update log, the server apparatus 3 notifies “discarded” to the client apparatus 2 (S29).

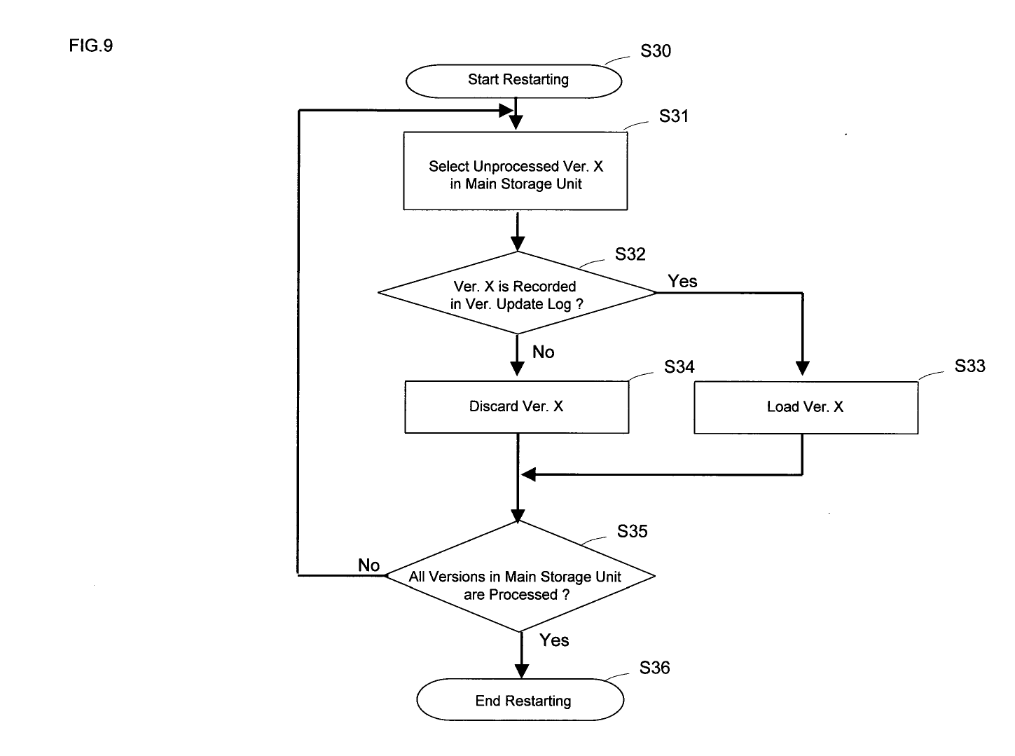

FIG. 9 is a flow chart of a flow of a recovery (restart) process from a server trouble. As shown in FIG. 9, once the server apparatus 3 starts the process of recovery (restart) from the trouble (S30), the server apparatus 3 selects one of the versions (for example, version X) stored in the main storage unit 4 (S31). The server apparatus 3 then determines whether the version X is a version recorded in the version update log (S32).

If the version X is recorded in the version update log, the server apparatus 3 loads the version X (S33). On the other hand, if the version X is not recorded in the version update log, the server apparatus 3 discards the version X (S34). When the server apparatus 3 executes the process for all versions stored in the main storage unit 4 (S36), the restart process of the server apparatus 3 ends (S37).

According to the embodiment of the present invention, the database management server 3 includes an update requesting unit that accepts an update request from the client apparatus 2 regardless of whether a new version is being created and the version creating unit 5 that creates a next version in response to an update request accepted in an period for accepting started in response to the update request. Therefore, the consistency of updates is maintained, and the occurrence of blocking execution in the update process can be prevented.

More specifically, according to the present embodiment, when an update request is sent from the client apparatus 2, the request is accepted as an update for a next version (for example, version X+1) during the creation of a new version (for example, version X) of databases, and an period for accepting the update request for the next version is started. The period for accepting the update request ends after a predetermined time, and the update requests accepted in the period for accepting are organized to create the next version. In this way, the occurrence of blocking execution in the update process (waiting time until the acceptance of the update request) can be prevented. The consistency of updates is also maintained by the management of generation-management databases.

According to the present embodiment, the existence of a collision between an update request from the client apparatus 2 in the period for accepting and an update request accepted in the past can be determined. If there is no update collision, a scheduled version name is notified as an acceptance completion notification of the update request. The use of the scheduled version name as an acceptance completion notification of the update request allows the client apparatus 2 that has sent the update request to check whether the update request is accepted and to recognize the version that the update request will be reflected.

According to the present embodiment, a scheduled version name is notified in response to the update request from the client apparatus 2. As a result, the client apparatus 2 that has sent the update request can quickly check whether the update request is accepted and immediately recognize the version that the update request will be reflected. Therefore, for example, when a trouble occurs in the database management server apparatus 3 after the transmission of the update request, whether the update request is accepted, or whether the update request is reflected, can be easily checked after the recovery process from the trouble.

According to the present embodiment, when the creation of a new version of the databases is completed, the completion of the creation of the version is recorded in the update log. When a trouble occurs in the database management server apparatus 3, the version being created in which the completion of the creation is not recorded in the update log is discarded in the recovery process from the trouble. The update state (such as “creation completed” and “discarded”) of the version of the databases is notified in response to the confirmation request from the client apparatus 2. Therefore, the client apparatus 2 can easily check whether the version reflecting the transmitted update request is created, or whether the transmitted update request needs to be resent, when a trouble occurs in the database management server apparatus 3.

According to the present embodiment, the version name (including the scheduled version name) remains in the update log even if the version of the databases is deleted. Therefore, whether the version of the databases with a certain version name existed in the past, or for example, whether the update request that one has sent in the past is reflected, can be easily checked even after the deletion of the version of the databases. This works with very low overhead because a significantly less amount of data is required for the version name of the databases compared to the entities of the databases.

According to the present embodiment, the end of the period for accepting the update request is set after the completion of the creation of the new version. In this case, the creation of the next version (version in which the accepted update request will be reflected) cannot be started until the completion of the creation of the new version (version being created). Therefore, the acceptance of the update request for the next version is designed to end after the completion of the creation of the new version. As a result, the efficiency of the update acceptance can be improved.

According to the present embodiment, the end of the period for accepting the update request is determined in response to the number of acceptances of the update requests. For example, the period for accepting the update request is designed to end when a certain number of update requests are accepted. As a result, the period for accepting the update request can be controlled to a suitable length.

The embodiment of the present invention has been described with examples. However, the scope of the present invention is not limited to these, and the present invention can be changed or modified according to an objective within the scope described in the claims.

As described, the database management system according to the present invention can maintain the consistency of updates and prevent occurrence of blocking execution in the update process. The database management system is used for managing generation-management databases and the like and is useful.

1. A database management server apparatus having a function of nondestructively updating databases in response to an update request from a client apparatus to manage generation-management databases, the database management server apparatus comprising:
version storage means which stores entities of a plurality of databases for each version of the databases;
version creating means which creates a new version of the databases in response to an update request from the client apparatus;
update request accepting means which accepts an update request for a next version of the databases from the client apparatus regardless of whether the new version is being created; and
acceptance management means which starts an period for accepting update requests to make the next version in response to the update request from the client apparatus and which ends the period for accepting update requests to make the next version after a predetermined time, wherein
the version creating means creates the next version of the databases in response to the update request for the next version accepted in the period for accepting.

2. The database management server apparatus according to claim 1, further comprising:
update collision determining means which determines whether there is a collision between the update request from the client apparatus in the period for accepting and an update request accepted in the past; and
scheduled version name notification means which notifies a scheduled version name of the databases to the client apparatus when the update collision determining means determines that there is no update collision, the scheduled version name being provided as an acceptance completion notification of the update request from the client apparatus.

3. The database management server apparatus according to claim 2, wherein
the scheduled version name notification means notifies the scheduled version name of the database to the client apparatus in response to the update request from the client apparatus.

4. The database management server apparatus according to claim 1, further comprising:
update log storage means which stores an update state of each version of the databases, the update state being provided as an update log of the databases;
update state notification means which notifies the update state of the version of the databases in response to a confirmation request from a client apparatus;
creation log recording means which records the completion of the creation of the new version in the update log when the creation of the new version of the databases is completed; and
discarding means which discards, in a recovery process from a trouble of the database management server apparatus, the version being created in which the completion of the creation is not recorded in the update log when the trouble occurs.

5. The database management server apparatus according to claim 1, further comprising:
version deleting means which deletes a version of the databases; and
deleted log recording means which saves the deleted version name of the databases as an update log of the database when the version is deleted.

6. The database management server apparatus according to claim 1, wherein
the acceptance management means sets the end of the period for accepting the update request to after the completion of the creation of the new version, when the update request for the next version is accepted from the client apparatus during the creation of the new version.

7. The database management server apparatus according to claim 1, wherein
the acceptance management means determines the end of the period for accepting the update request according to the number of acceptances of the update requests, when the update requests of the next version are accepted from the client apparatus during the creation of the new version.

8. A database management system comprising:
a client apparatus having a function of sending an update request for databases; and
a database management server apparatus having a function of nondestructively updating the databases in response to the update request from the client apparatus to manage generation-management databases, the database management server apparatus comprising:
version storage means which stores entities of a plurality of databases for each version of the databases;
version creating means which creates a new version of the databases in response to an update request from the client apparatus;
update request accepting means which accepts an update request for a next version of the databases from the client apparatus regardless of whether the new version is being created; and
acceptance management means which starts an period for accepting the update request for the next version in response to the update request from the client apparatus and which ends the period for accepting the update request for the next version after a predetermined time, wherein
the version creating means creates the next version of the databases in response to the update request for the next version accepted in the period for accepting.

9. A database management method used in a database management server apparatus having a function of nondestructively updating databases in response to an update request from a client apparatus to manage generation-management databases,
the database management server apparatus storing entities of a plurality of databases for each version of the databases and having a function of creating a new version of the databases in response to an update request from the client apparatus;
the database management method comprising:
accepting an update request for a next version of the databases from the client apparatus regardless of whether the new version is being created;
starting a period for accepting the update request for the next version in response to the update request from the client apparatus and ending the period for accepting the update request for the next version after a predetermined time; and
creating the next version of the databases in response to the update request for the next version accepted in the period for accepting.

10. A database management program executed in a database management server apparatus having a function of nondestructively updating databases in response to an update request from a client apparatus to manage generation-management databases,
the database management server apparatus storing entities of a plurality of databases for each version of the databases and having a function of creating a new version of the databases in response to an update request from the client apparatus;
the database management program causing a computer to execute:
a process of accepting an update request for a next version of the databases from the client apparatus regardless of whether the new version is being created;
a process of starting a period for accepting the update request for the next version in response to the update request from the client apparatus and ending the period for accepting the update request for the next version after a predetermined time; and
a process of creating the next version of the databases in response to the update request for the next version accepted in the period for accepting.
